(19) United States
(12) Patent Application Publication
(10) Pub. No.: US 2009/0101466 A1
(43) Pub. Date: Apr. 23, 2009

(54) Freewheeling Roll and Brake

(75) Inventor: Xavier Karcher, La Motte Achard (FR)

Correspondence Address: CASELLA & HESPOS, 274 MADISON AVENUE, NEW YORK, NY, 10016, US

(73) Assignee: Interroll Holding AG, Sant'Antonino (CH)

(21) Appl. No.: 12/226,442

(22) PCT Filed: Apr. 20, 2007
(86) PCT No.: PCT/EP2007/003502

§ 371 Date: Oct. 17, 2008

(30) Foreign Application Priority Data
Apr. 21, 2006 (EP) 06290665.6

(51) Int. Cl. B65G 13/075

(52) U.S. Cl. 193/35 A

(57) ABSTRACT

A conveying roll has a cover (20) mounted on a bearing point (40) so that the conveying roll can be twisted relative to the bearing point (40) about an axis of rotation. A brake (50) is provided kinematically between the bearing point (40) and the cover (20) and is designed so the difficulty of twisting the cover relative to the bearing point about the axis of rotation varies in accordance with relative rotational speed between the cover (20) and the bearing point (40). An impeding device (60) is disposed between the bearing point (40) and the cover (20) at a point in the braking train of the brake and allows or prevents the brake to have or from having a braking effect in accordance with a direction of rotation of the cover relative to the bearing point (40).

### BACKGROUND OF THE INVENTION

1. Field of the Invention

The invention relates to a conveying roller and to a conveying path comprising a conveying roller.

2. Description of the Related Art

Roller conveyors with rollers exist in the prior art. These roller conveyors are used, for example, in rack storage systems, wherein a rack can have a plurality of roller conveyors arranged above and alongside one another. A plurality of pallets with goods can be mounted one behind the other on a roller conveyor, these pallets running on the rollers.

The roller conveyors are generally loaded either from one side and unloaded from the other side, with the result that the goods which pass onto the roller conveyors first are also unloaded again first therefrom. These rack storage systems are known as first-in/first-out storage systems or fifo storage systems. Some of these fifo roller conveyors have an inclination which slopes from the loading point to the unloading point, with the result that pallets which are situated on the roller conveyor are conveyed by gravitational force in the direction of the unloading point.

In another alternative, the roller conveyors are loaded from one side and unloaded from the same side, with the result that the goods which pass onto the roller conveyors last are unloaded first therefrom. These rack storage systems are known as last-in/first-out storage systems or lifo storage systems. Some of these storage systems also have an inclination in the direction of the loading or unloading point. When loading a further new pallet, for example by means of a forklift truck, the pallets which are already situated on the roller conveyor are pushed rearward by the new pallet counter to the inclination. Moreover, this inclination has the effect that the pallets which are situated on the roller conveyor always line up at the unloading point following the gravitational force.

In order to brake the speed of the pallets with the goods in the roller conveyors, the rollers of the conveying paths are in part provided with brakes via which the speed of the rollers, and hence that of the pallets, can be braked, thereby preventing the pallets from running against one another at excessively high speed. For this purpose, use is made of brakes which are arranged on the inside of the rollers.

Such braked rollers can be damaged or destroyed if pallets are pushed, for example by means of a forklift truck, at excessively high speed and with great pushing force onto the roller conveyors, since designing the rollers and the braking devices which they contain to be sufficiently stable in order to withstand the pushing force of the forklift truck and with reasonable economic outlay can only be achieved with difficulty. As a result, additional repair and maintenance costs arise.

The object on which the invention is based is therefore to provide a conveying roller and a conveying path comprising at least one such conveying roller which are able to be produced in a favorable manner, which have a long service life and require low maintenance and/or repair costs over their service life.

### SUMMARY OF THE INVENTION

One aspect of the invention relates to a conveying roller comprising a casing element, a bearing and a braking device, wherein the bearing and the casing element are connected to one another such that the casing element can be mounted via the bearing on a bearing point in such a way that the conveying roller can be rotated relative to the bearing point about an axis of rotation, and wherein the braking device is provided kinematically between the bearing point and the casing element and is designed in such a way that a rotation of the casing element with respect to the bearing point about the axis of rotation can be made more difficult as a function of the relative rotational speed between the casing element and the bearing point, characterized by an inhibiting device which is provided at a point on a braking train of the braking device between the bearing point and the casing element and allows or prevents a braking action of the braking device as a function of a relative direction of rotation of the casing element with respect to the bearing point. This has the advantage that such conveying rollers, for example if during operation they are loaded in a loading direction by a forklift truck, are not braked in this direction, with the result that they do not counter the force of the forklift truck with a braking force and can therefore not be damaged by the force of the forklift truck during loading. By contrast, a braking action in the opposite direction is always allowed, with the result that reversing pallets can be braked. According to the particular area of use, a dependence of the braking action in the reversing direction can correspond to a discontinuous or in part continuous function; for example, a linear dependence between speed of rotation and braking force can be provided, with the braking force acting only above a minimum speed.

In such a conveying roller, the bearing point is preferably formed from an axle which can be fastened in a rotationally fixed manner to a roller frame at least in one direction of rotation, and/or wherein the bearing is formed from a rolling bearing and/or a plain bearing and/or wherein the braking device is a centrifugal brake, and/or wherein the inhibiting device is a freewheel. Freewheels have the advantage that they are quiet in operation and have a low frictional resistance in the freewheeling direction. By contrast, toothings which can be locked in one direction of rotation by means of a resilient pawl which engages in the toothing and are freewheeling in the other direction have the advantage that a higher torque can be transmitted. Rolling bearings have a lower frictional resistance than plain bearings, although plain bearings have a higher strength when subjected to impact loading. A centrifugal brake has the advantage that it is self-operated, with the result that the centrifugal force, and hence the braking force, is dependent on the rotational speed of the braking elements. Other design forms of inhibiting devices are also conceivable, such as, for example, clutches, brakes or the like.

It is advantageous if such a conveying roller further comprises a conversion means, and the braking device in such a conveying roller comprises a braking drive and a braking element, wherein the conversion means is designed in such a way that a relative movement between the casing element and the bearing point can be converted via the conversion means into a drive movement of a braking drive, and wherein the braking drive is designed such that it produces a braking force of braking elements of the braking device as a function of the drive movement. Advantages of such a design are that the movement of the conveying roller can be used to bring about the braking action. For this purpose, for example a gearset can be connected by way of a driver to braking elements of a centrifugal brake which are operated by centrifugal force. It is also possible, however, to use other rotational speed-force converters.

It is further considered advantageous if the conversion means in such a conveying roller is an epicyclic gearset which can be operated in two-shaft operation and/or in three-shaft operation and/or in multishaft operation, wherein at least a first drive is formed by the casing element or a part connected in a rotationally fixed manner to the casing element, and wherein an output is connected to the braking drive in a substantially rotationally fixed manner at least in one direction of rotation and/or a second drive is formed by the bearing point. It is thus possible, for example, even at a relatively slow rotational speed of the casing element, to achieve a sufficient rotational speed of a driver of a centrifugal brake in order to achieve a sufficient centrifugal force of braking elements of the centrifugal brake. Preference is given to using a single-stage or multistage planetary gearset in two-shaft operation or in three-shaft operation. Here, the drive in the bearing point is preferably fastened in a rotationally fixed manner in relation to the mounting of the conveyor roller in a roller frame. However, it is also possible to drive the bearing point, for example, externally in a separate manner, with the result that the relative speed between the drives can be varied and the braking action can thus be adjusted.

Preferably, such a conveying roller is designed in such a way that the inhibiting device is provided on the frame side on the bearing point and/or between the bearing point and conversion means and/or inside the conversion means and/or between the conversion means and braking device and/or between the braking device and casing element. A frame-side mounting of the inhibiting device has the advantage that it can be more easily retrofitted, for example, to existing roller conveyors. In addition, the inhibiting device is more readily accessible during maintenance and repair. A further advantage is that the remaining components of the conveying rollers can stay the same, with the result that such conveying rollers can be used with or without an inhibiting device in different conveying paths, which means that the manufacture for different conveying rollers using the same parts is cheaper. A mounting between the bearing point, in particular an axle, and the conversion means, in particular a planetary gearset, has the advantage that an inhibiting device has only to transmit the torques of the drive train but does not have to take up the load of the pallets. The other stated types of mounting also have this advantage. Furthermore, a mounting inside the conversion means or between the braking device and conversion means or between the braking device and casing element has the advantage that the mounting location can be chosen according to diameter, torque to be transmitted and rotational speed, with the result that the mounting can be optimally chosen with respect to application and cost.

It is preferable in such a conveying roller to provide the inhibiting device at a point on the braking train at which a minimum torque has to be transmitted by the inhibiting device during braking.

Also preferable is such a conveying roller in which the inhibiting device is provided at a point on the braking train at which a minimum difference in the speeds of rotation of the parts on both sides of the inhibiting device has to be bridged by the inhibiting device during a rotation counter to the direction of rotation during braking.

It is advantageous in such a conveying roller if the inhibiting device is provided at a point on the braking train at which impact loads which act on the conveying roller during operation do not act on the inhibiting device but are transmitted via other elements of the conveying roller to the bearing point.

It is also advantageous in such a conveying roller if the inhibiting device is provided at a point inside the casing element. This has the advantage that the inhibiting device is protected from environmental effects.

A further aspect of the invention relates to a conveying path comprising a frame, characterized in that at least one conveying roller as claimed in one of the preceding claims is mounted in the frame.

Such a conveying path is preferably inclined with respect to the horizontal in a conveying direction or counter to the conveying direction, wherein the conveying roller is mounted in an orientation transversely to the conveying direction in such a way that a braking action of the braking device is allowed in the direction facing downward along the conveying path and is prevented in a direction facing upward along the conveying path.

It is advantageous in such a conveying path if it is designed such that both a loading point, from which the conveying path can be loaded with goods, and an unloading point, from which the goods can be unloaded again, are situated on the same side of the conveying path.

Such a conveying path preferably comprises conveying rollers in which the inhibiting devices are each arranged at different points, in particular at least one conveying roller in which the inhibiting device is arranged on the frame side on the bearing point, and also at least one conveying roller in which the inhibiting device is arranged at a point at which impact loads which act on the conveying roller during operation do not act on the inhibiting device. This has the advantage that, in regions in which impact loads occur to an increased degree, for example at the loading and unloading points, the inhibiting devices can be arranged such that they do not have to be designed for the impact loading, whereas a more cost-effective arrangement can be chosen for other conveying rollers. It is also conceivable for only some of the conveying rollers to be braked and/or equipped with an inhibiting device.

### BRIEF DESCRIPTION OF THE DRAWINGS

FIG. 1 shows an exploded drawing of a preferred embodiment of a conveying roller according to the invention in an isometric view,

FIG. 2 shows a section through a preferred embodiment of a conveying roller according to the invention and a plan view of an end face of a conveying roller, and

FIG. 3 shows an embodiment of an inhibiting device according to the invention.

### DETAILED DESCRIPTION OF THE PREFERRED EMBODIMENTS

Individual particularly preferred embodiments of the invention are described below. Here, the individual embodiments described have to some extent features which are not absolutely necessary in order to implement the present invention but which are generally considered to be preferable. Thus, embodiments which do not have all the features of the embodiments described below should also be considered to come within the teaching of the invention. It is equally conceivable for features which are described with reference to different embodiments to be selectively combined with one another.

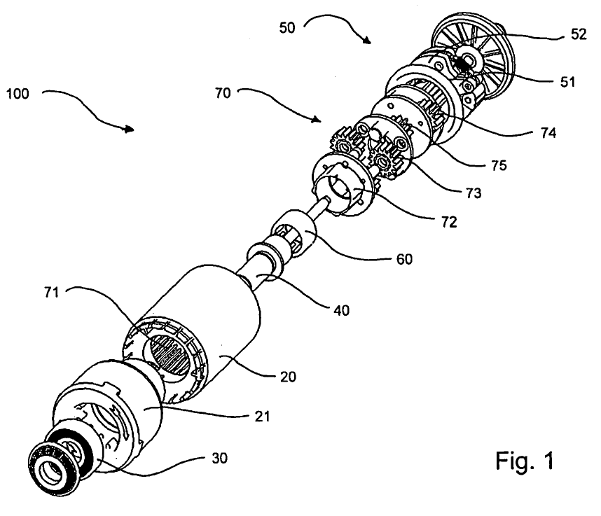

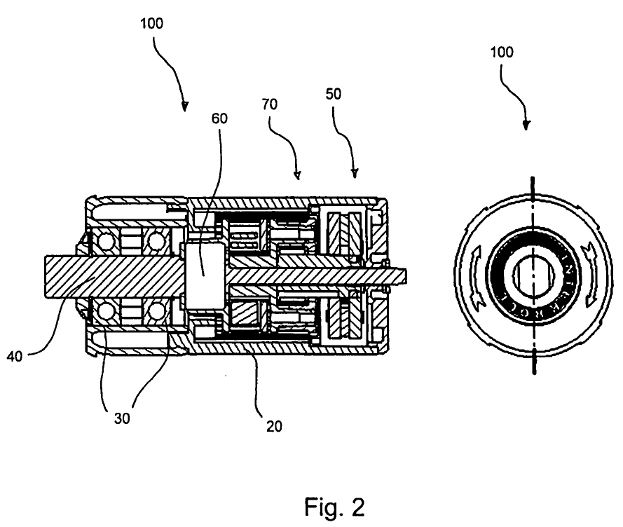

FIG. 1 shows an exploded drawing of a preferred embodiment of a conveying roller according to the invention in an isometric view. The conveying roller represented comprises a casing element 20 which has an internal toothing 71 on its inner side. As shown on the bottom left side of the drawing, the casing element 20 is connected in a rotationally fixed manner to a coupling element 21 into which there is concentrically inserted a bearing 30 which, in the preferred embodiment represented, is formed from rolling bearings. It is evident from FIG. 2 that the rolling bearings are two grooved ball bearings. The coupling element 21 here has the same outside diameter as the casing element 20, with the result that a substantially smooth cylindrical outer surface of the conveying roller is formed. It is also conceivable for the cylindrical outer surface of the conveying roller to be formed by a one-piece component or for the outer surface to be composed of a plurality of parts. It is also possible for the bearing 30 to comprise other bearing types instead of the rolling bearing or in addition to the rolling bearing, for example plain bearings. Plain bearings have, for example, the advantage that they are less sensitive to impacts and can bear higher loads, whereas rolling bearings are distinguished by the fact that they have a particularly low frictional resistance.

The casing element 20 is rotatably mounted, via the bearing 30, on a bearing point 40 which, in the preferred embodiment, is formed from an axle which is fitted through the rolling bearing. The axle is used to mount the conveying roller 100 on a roller frame, which is not shown in the figures. The bearing point 40—that is to say the axle in the embodiment represented—is generally mounted in a rotationally fixed manner in the roller frame. However, it is also conceivable for the axle to be driven in such a way that the relative speed between the casing element 20 and axle can be variably controlled.

The axle extends substantially through the casing element 20 and, with the conveying roller 100 in the assembled state, projects on the other side from the conveying roller 100. Inside the conveying roller 100, an inhibiting device 60, a conversion means 70 and a braking device 50 are mounted on the axle. In the embodiment represented, the inhibiting device 60 is designed as a freewheel and the conversion means 70 comprises an epicyclic gearset which, in the embodiment represented, is a two-stage planetary gearset. The braking device 50 is designed as a centrifugal brake.

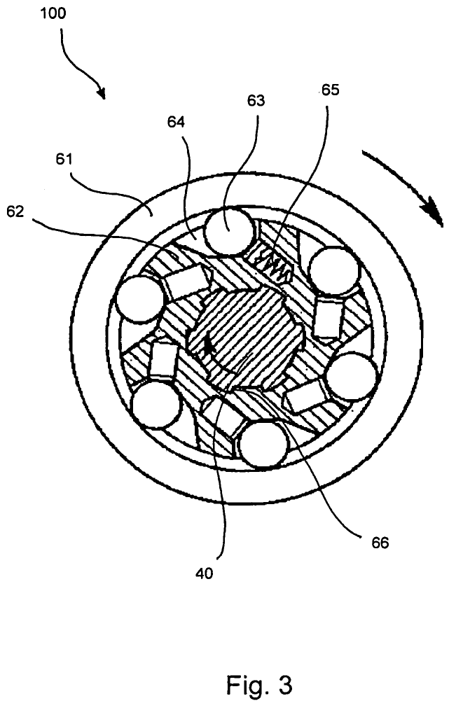

FIG. 3 is a cross-sectional view showing an embodiment of the inhibiting device 60 in a state in which the inhibiting device 60 is mounted on the bearing point 40. There is represented a splined-shaft toothing 66 which constitutes a shaft-hub connection between an inner element 62 of the inhibiting device 60 and the axle. Other types of connection, for example a press fit, shrink fits, etc., are also conceivable.

The inhibiting device 60 further comprises an outer element 61 and locking balls 63 which are mounted in recesses 64 of the inner element 62 and which have a spring force applied to them via spring elements 65, likewise accommodated in the inner element 62, and are pressed by this spring force into a locking direction. The spring force ensures that the locking balls 63 are each in contact with the surfaces of the recesses 64 and on the other hand with the surface of the inner side of the outer element 61. If the outer element 61 and the inner element 62 are rotated with respect to one another in the locking direction, the locking balls 63 run along those surfaces of the recesses 64 which rise in the locking direction. As a result, the pressing force in the radial direction between the locking balls 63 and the two surfaces of the recesses 64 and the outer element 61 is increased. The increase in the pressing force also leads to an increase in the frictional force which can be transmitted, resulting in self-locking between the inner element 62 and the outer element 61 in the locking direction. In a direction of rotation counter to this locking direction, the locking balls 63 run into deeper regions of the recesses 64, with the result that a sufficient spacing is formed between the surfaces of the recesses 64 and the surface of the inner side of the outer element 61, which means that the locking balls 63 bear only under the application of the spring force against the inner side of the outer element 61. In this case, the contact force between the locking balls 63 and the inner surface of the outer element 61 is small enough that, in a direction of rotation counter to the locking direction, a lubricating film can form between the locking balls 63 and the outer element 61. In this direction of rotation, the outer element 61 therefore runs in a substantially friction-free manner around the inner element 62.

The ball-bearing freewheel described is only one of many suitable freewheels available on the market. Also available are freewheels without springing, with cylindrical rollers instead of the balls and/or freewheels with clamping elements. Such clamping elements are provided at the contact surfaces with a specifically configured geometry which, in frictional contact with the rotationally symmetrical coupling parts, produces a defined clamping angle. When taking up loads, the clamping element rolls inward along its clamping surface until there is force equilibrium between the torque arising and the stress on the freewheel parts.

In some cases, such freewheels are not self-centering. Therefore, the centered running of the inner clamping track with respect to the outer one must be ensured by means of a suitable mounting arrangement. Correspondingly mounted system solutions and individual freewheels are available on the market as standard parts or as special designs.

As is shown in FIG. 1, the freewheel is mounted on the axle and connects a planet carrier 72 of the epicyclic gearset to the axle. Accordingly, this planet carrier 72 is freely rotatable on the axle in one direction, whereas it is fastened in a rotationally fixed manner on the axle in the other direction. On the planet carrier 72 are situated first planet gears 73 which are in engagement with the internal toothing 71 in the casing element 20 on one side and which on the other side are in engagement with a first sun gear 75 which is designed to be rotationally fixed on a second planet carrier and rotatable on the axle. On the second planet carrier in turn are rotatably mounted second planet gears 74 which in turn mesh with the internal toothing 71 of the casing element 20 and on the other side mesh with a second sun gear (not shown in FIG. 1) which is connected in a rotationally fixed manner to a driver 51 of the braking device 50.

By virtue of the mechanism represented, a rotation of the casing element 20 in a locking direction of the freewheel is converted via the conversion means 70 into a very much quicker rotation of the driver 51 of the braking device 50. As a result of this rotational speed of the driver 51, a braking element 52, which is driven along by the driver 51, has a centrifugal force applied thereto and is pressed by means of this centrifugal force against an inner surface of the casing element 20, this surface (not shown in FIG. 1) being situated behind the internal toothing 71 as viewed axially in a direction toward the upper right in FIG. 1. Through the different rotational speeds of the driver 51 and the casing element 20 and through the pressing force with which the braking element 52 is pressed against the inner surface of the casing element 20, there is produced a braking force which acts counter to the direction of rotation of the casing element 20.

By contrast, in a direction of rotation of the casing element 20 counter to the locking direction of the freewheel, the frictional engagement of the casing element 20 with the braking device 50 is interrupted, with the result that the casing element 20 can rotate in a substantially unbraked manner.

In the embodiment shown in FIG. 1, the freewheel is, as represented, arranged on the axle between the axle and the first planet carrier 72. Further embodiments in which the freewheel is arranged at other points along the drive train are conceivable. It is conceivable for instance to provide small freewheels inside the planet gears of one of the two planet gear stages or both planet gear stages, and/or to provide freewheels between the internal toothing 71 and the casing element 20. In a further embodiment, such a freewheel can be mounted on the outside of the conveying roller 100 between the axle and the roller frame. The mounting point of one or more freewheels depends on various operating conditions under which conveying rollers are used.

If such conveying rollers are used, for example, in a region of a conveying path in which pallets are set down on the conveyor, relatively large impact forces act on the rollers. In this case, a freewheel which is arranged on the outside of the conveying roller—that is to say between the axle and roller bearing—would have to be designed for a corresponding impact loading. Therefore, it can be considered to be advantageous to arrange the freewheel inside the conveyor roller such that impact forces are not absorbed by the freewheel but by the bearing arrangement of the conveyor roller via the rolling bearings.

On the other hand, it may be advantageous for the freewheel to be arranged on the outside of the conveying roller 100, for example in a region in which relatively few impact loads if any act on the conveying roller 100. The freewheel can be mounted in a readily accessible manner at this point, which means, for example, that existing systems can be retrofitted with such freewheels.

A further criterion for the arrangement of freewheels along the drive train of the braking device 50 depends on the overall size of the freewheels available, on the torques to be transmitted and on the rotational speeds for which freewheels are designed. Thus, for example, a freewheel at a location as represented in FIG. 1 has to transmit a relatively high torque at low rotational speed, whereas, for example, a freewheel between the sun gear of the second planet gear stage and the driver 51 of the braking device 50 would have to transmit a low torque at a high rotational speed.

A freewheel in turn which were arranged between the casing element 20 and the internal toothing 71 would have a relatively large diameter, which is available at this installation point. Therefore, a freewheel which is produced from plastic elements might possibly be suitable. Since the torque of freewheels which can be transmitted is generally limited by the Hertzian contact stress between the blocking elements and the surfaces of the outer element 61 and the inner element 62, the torque to be transmitted substantially depends on the materials used, on the surface curvatures and on the curvatures of the blocking elements. Therefore, it is possible for a plurality of blocking elements to be provided at an installation point at which sufficient space is available, with the result that less resistant materials, such as, for example, plastics, are also suitable for the parts.

FIG. 2 shows a section through the preferred embodiment of the conveying roller from FIG. 1 and a plan view of an end face of the conveying roller. In FIG. 2, the conveying roller 100 is shown in the assembled state. The same components are designated by the same reference numbers as in FIG. 1.

FIG. 3 shows an embodiment of an inhibiting device according to the invention.

A conveying path which forms the subject of the invention will be described below. The conveying path will be described without reference to the figures. Such a conveying path comprises a frame in which a large number of rollers is generally mounted. These rollers may in part be braked rollers as have been described above. Other rollers may be unbraked. Other rollers in turn may have a dedicated drive.

A conveying path according to the invention comprises at least one conveying roller 100 according to the invention. Preference is given to arranging such a conveying roller 100 in a region of the conveying path in which goods which are situated on the conveying path are intended to be braked in one direction of travel and are intended to be able to move unbraked in the other conveying direction. Such a region exists, for example, in conveying paths and in flow-storage modules.

Such flow-storage modules have storage spaces for pallets. Here, a plurality of pallets are mounted one behind the other on a conveying path, wherein the conveying path is loaded and unloaded from one side or is loaded from one side and unloaded from the other side. Conveying paths which are loaded and unloaded from one side are generally referred to as “last-in/first-out” or as “lifo” conveying paths. In the case of these lifo conveying paths, a pallet is supplied, for example, by a forklift truck, the forklift truck uses the pallet to push the other pallets already situated on the conveying path upwardly counter to an inclination and deposits the new pallet on the conveying path. The other pallets, following the gravitational force, then run toward the unloading point again. Here, the pallets are to be braked in the downward-sloping direction in order to prevent the pallets from bumping against one another at relatively great speed.

It may occur in this arrangement that as the forklift trucks push against the pallets situated on the conveying path, these pallets are pushed at excessive speed. If the conveying rollers of such a conveying path are also braked in this direction, the conveying rollers would have to be able to withstand the pushing force of such a forklift truck. Therefore, use is preferably made in such conveying paths of the conveying rollers according to the invention. In this case, the conveying rollers are installed in such a conveying path in such a way that the conveying rollers are unbraked in the upward direction of inclination of the conveying path, whereas the braking action of the conveying rollers acts in the opposite direction of the conveying path, that is to say in the downward-sloping direction.

In such a conveying path, the conveying rollers which are arranged in the withdrawal region or in the loading region can be equipped with freewheels which are arranged in a region of the conveying roller which is not adversely affected during impact loading of the conveying rollers. By contrast, those rollers which are arranged further away from the unloading region can be equipped with freewheels which are arranged between the axles of the conveying rollers and the frame of the conveying path.

1. A conveying roller (100) comprising a casing element (20), a bearing (30) and a braking device (50), wherein the bearing (30) and the casing element (20) are connected to one another such that the casing element (20) can be mounted via the bearing (30) on a bearing point (40) in such a way that the conveying roller (100) can be rotated relative to the bearing point (40) about an axis of rotation, and wherein the braking device (50) is provided kinematically between the bearing point (40) and the casing element (20) and is designed in such a way that a rotation of the casing element with respect to the bearing point (40) about the axis of rotation can be made more difficult as a function of the relative rotational speed between the casing element (20) and the bearing point (40), characterized by an inhibiting device (60) which is provided at a point on a braking train of the braking device between the bearing point (40) and the casing element (20) and allows or prevents a braking action of the braking device (50) as a function of a relative direction of rotation of the casing element with respect to the bearing point (40).

2. The conveying roller (100) as claimed in claim 1, wherein the bearing point (40) is formed from an axle which can be fastened in a rotationally fixed manner to a roller frame, and/or wherein the bearing (30) is formed from a rolling bearing and/or wherein the braking device (50) is a centrifugal brake, and/or wherein the inhibiting device (60) is a freewheel.

3. The conveying roller (100) as claimed in claim 1, which further comprises a conversion means (70), and in which the braking device (50) comprises a braking drive, wherein the conversion means (70) is designed in such a way that a relative movement between the casing element (20) and the bearing point (40) can be converted via the conversion means (70) into a drive movement of a braking drive, and wherein the braking drive is designed in such a way that it produces a braking force of the braking device (50) as a function of the drive movement.

4. The conveying roller (100) as claimed in claim 3, wherein the conversion means (70) is an epicyclic gearset which can be operated in two-shaft operation and/or in three-shaft operation and/or in multishaft operation, wherein at least a first drive is formed by the casing element (20), an output is connected in a rotationally fixed manner to the braking drive and/or a second drive is formed by the bearing point (40).

5. The conveying roller (100) as claimed in claim 1, wherein the inhibiting device (60) is provided on the frame side on the bearing point (40) and/or between the bearing point (40) and conversion means (70) and/or inside the conversion means and/or between the conversion means (70) and braking device (50) and/or between the braking device (50) and casing element (20).

6. The conveying roller (100) as claimed in claim 1, wherein the inhibiting device (60) is provided at a point on the braking train at which a minimum torque has to be transmitted by the inhibiting device (60) during braking.

7. The conveying roller (100) as claimed in claim 1, wherein the inhibiting device (60) is provided at a point on the braking train at which a minimum difference in the speeds of rotation of the parts on both sides of the inhibiting device (60) has to be bridged by the inhibiting device (60) during a rotation counter to the direction of rotation during braking.

8. The conveying roller (100) as claimed in claim 1, wherein the inhibiting device (60) is provided at a point on the braking train at which impact loads which act on the conveying roller (100) during operation do not act on the inhibiting device (60) but are transmitted via other elements of the conveying roller (100) to the bearing point (40).

9. The conveying roller (100) as claimed in claim 1, wherein the inhibiting device (60) is provided at a point inside the casing element.

10. A conveying path comprising a frame and at least one conveying roller (100) mounted in the frame, the conveying roller having a casing element (20), a bearing (30) and a braking device (50), wherein the bearing (30) and the casing element (20) are connected to one another such that the casing element (20) can be mounted via the bearing (30) on a bearing point (40) in such a way that the conveying roller (100) can be rotated relative to the bearing point (40) about an axis of rotation, and wherein the braking device (50) is provided kinematically between the bearing point (40) and the casing element (20) and is designed in such a way that a rotation of the casing element with respect to the bearing point (40) about the axis of rotation can be made more difficult as a function of the relative rotational speed between the casing element (20) and the bearing point (40), characterized by an inhibiting device (60) which is provided at a point on a braking train of the braking device between the bearing point (40) and the casing element (20) and allows or prevents a braking action of the braking device (50) as a function of a relative direction of rotation of the casing element with respect to the bearing point (40).

11. The conveying path as claimed in claim 10, which is inclined with respect to the horizontal in a conveying direction or counter to the conveying direction, wherein the conveying roller (100) is mounted in an orientation transversely to the conveying direction in such a way that a braking action of the braking device (50) is allowed in the direction facing downward along the conveying path and prevented in the direction facing upward along the conveying path.

12. The conveying path as claimed in claim 10, which is designed such that both a loading point, from which the conveying path can be loaded with goods, and an unloading point, from which the goods can be unloaded again, are situated on the same side of the conveying path.

13. The conveying path as claimed in claim 10, which comprises conveying rollers in which the inhibiting devices are each arranged at different points, in particular at least one conveying roller in which the inhibiting device (60) is arranged on the frame side on the bearing point (40), and also at least one conveying roller in which the inhibiting device (60) is arranged at a point at which impact loads which act on the conveying roller during operation do not act on the inhibiting device (60).
